(19) United States
(12) Patent Application Publication
(10) Pub. No.: US 2015/0170070 A1
(43) Pub. Date: Jun. 18, 2015

(54) METHOD, APPARATUS, AND SYSTEM FOR MONITORING WEBSITE

(71) Applicant: TENCENT TECHNOLOGY (SHENZHEN) COMPANY LIMITED, Shenzhen (CN)

(72) Inventors: FUYONG HE, Shenzhen (CN); YIQING TIAN, Shenzhen (CN); QICHEN XU, Shenzhen (CN)

(73) Assignee: TENCENT TECHNOLOGY (SHENZHEN) COMPANY LIMITED

(21) Appl. No.: 14/615,583

(22) Filed: Feb. 6, 2015

Related U.S. Application Data
(63) Continuation of application No. PCT/CN2014/078736, filed on May 29, 2014.

(30) Foreign Application Priority Data
Aug. 5, 2013 (CN) 2013-10337340.9

(51) Int. Cl. G06Q 10/06; H04L 12/26; H04L 29/08

(52) U.S. Cl. CPC G06Q 10/063; H04L 67/12; H04L 43/06

(57) ABSTRACT

Methods, apparatus, and systems for monitoring a website are provided. A monitoring instruction sent from a monitoring platform is received to obtain information of a business service point to be monitored of the website. Service data corresponding to the triggered business service point are obtained, when that the business service point to be monitored of the website is triggered has been detected, and when the triggered business service point contains a buried-point for data collection. The obtained service data are then updated to the monitoring platform for the monitoring platform to monitor the website. A system includes a business apparatus and a monitoring platform. A business apparatus includes a monitoring-information obtaining module, a data collecting module, and a data uploading module.

### CROSS-REFERENCES TO RELATED APPLICATIONS

This application is a continuation application of PCT Patent Application No. PCT/CN2014/078736, filed on May 29, 2014, which claims priority to Chinese Patent Application No. 2013103373409, filed on Aug. 5, 2013, the entire contents of which are incorporated herein by reference.

### FIELD OF THE DISCLOSURE

The present disclosure generally relates to the field of computer software and network technology and, more particularly, relates to methods, apparatus, and systems for monitoring a website.

### BACKGROUND

With rapid growth of the Internet, there are more personal websites, enterprise websites, and community websites that can be accessed online. Competition between these websites increases. Website monitoring is derived. The website monitoring is conducted by a corresponding webmaster, enterprise, and community using software products, or conducted by a website monitoring service provider to monitor the website and to obtain data for website debugging and data analysis.

Conventional methods for monitoring website include: an external simulation transaction monitoring by deploying nodes across a region (e.g., a country) to send data packets to the monitored websites and thus to monitor the network quality of the websites (including those can be monitored by different suppliers) all over the country. This can effectively know in which area the monitored websites have network latency and blind spots.

Conventional methods for monitoring website also include: internal reporting or capturing of the monitored data by deploying server-side device agent programs to initiate a report to the monitoring center, or by having the monitoring center initiate a report, or by having the monitoring center initiatively send the data request to the monitored device.

However, it is desirable to monitor the websites at node level of the business and thus to eliminate blind spot during the monitoring.

### BRIEF SUMMARY OF THE DISCLOSURE

One aspect or embodiment of the present disclosure includes a method of monitoring a website. In the method, a monitoring instruction sent from a monitoring platform is received to obtain information of a business service point to be monitored of the website. Service data corresponding to the triggered business service point are obtained, when that the business service point to be monitored of the website is triggered has been detected, and when the triggered business service point contains a buried-point for data collection. The obtained service data are then updated to the monitoring platform for the monitoring platform to monitor the website.

Another aspect or embodiment of the present disclosure includes a business apparatus. The business apparatus includes a monitoring-information obtaining module, a data collecting module, and a data uploading module.

The monitoring-information obtaining module is configured to receive a monitoring instruction sent from a monitoring platform, and obtain information of a business service point to be monitored of the website. The data collecting module is configured to obtain service data corresponding to the triggered business service point, when that the business service point to be monitored of the website is triggered has been detected, and when the triggered business service point contains a buried-point for data collection. The data uploading module is configured to upload the service data to the monitoring platform to monitor the website by the monitoring platform.

Another aspect or embodiment of the present disclosure includes a method of monitoring a website. A business apparatus receives a monitoring instruction sent from a monitoring platform to obtain information of a business service point to be monitored. The business apparatus obtains service data corresponding to the triggered business service point, when that the business service point to be monitored of the website is triggered has been detected, and when the triggered business service point contains a buried-point for data collection. The business apparatus updates the obtained service data to the monitoring platform to monitor the website by the monitoring platform. The monitoring platform monitors the website according to the uploaded service data.

Another aspect or embodiment of the present disclosure includes a system of monitoring a website. The system includes a business apparatus and a monitoring platform. The business apparatus includes: a monitoring-information obtaining module, a data collecting module, and a data uploading module.

The monitoring-information obtaining module is configured to receive a monitoring instruction sent from a monitoring platform, and obtain information of a business service point to be monitored of the website. The data collecting module is configured to obtain service data corresponding to the triggered business service point, when that the business service point to be monitored of the website is triggered has been detected, and when the triggered business service point contains a buried-point for data collection. The data uploading module is configured to upload the service data to the monitoring platform to monitor the website by the monitoring platform. The monitoring platform is configured to monitor the website according to the uploaded service data.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for monitoring a website consistent with various disclosed embodiments;

FIG. 2 depicts another exemplary method for monitoring a website consistent with various disclosed embodiments;

FIG. 3 depicts an exemplary business apparatus having functional modules for monitoring a website consistent with various disclosed embodiments;

FIG. 4 depicts another exemplary business apparatus having functional modules for monitoring a website consistent with various disclosed embodiments;

FIG. 5 depicts another exemplary method for monitoring a website consistent with various disclosed embodiments;

FIG. 6 depicts another exemplary method for monitoring a website consistent with various disclosed embodiments;

FIG. 7 depicts an exemplary method for monitoring uploaded service data when monitoring a website consistent with various disclosed embodiments;

FIG. 8 depicts an exemplary monitoring graph displayed when monitoring a website as shown in FIG. 7 consistent with various disclosed embodiments;

FIG. 9 depicts another exemplary method for monitoring uploaded service data when monitoring a website consistent with various disclosed embodiments;

FIG. 10 depicts an exemplary monitoring graph displayed when monitoring a website as shown in FIG. 7 having a monitored buried-point of a debugging buried-point consistent with various disclosed embodiments;

FIG. 11 depicts an exemplary monitoring graph displayed when monitoring a website as shown in FIG. 7 having a monitored buried-point of a business buried-point consistent with various disclosed embodiments;

FIG. 12 depicts an exemplary system for monitoring a website having functional modules consistent with various disclosed embodiments;

FIG. 13 depicts an exemplary environment incorporating certain disclosed embodiments; and

FIG. 14 depicts an exemplary computer system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

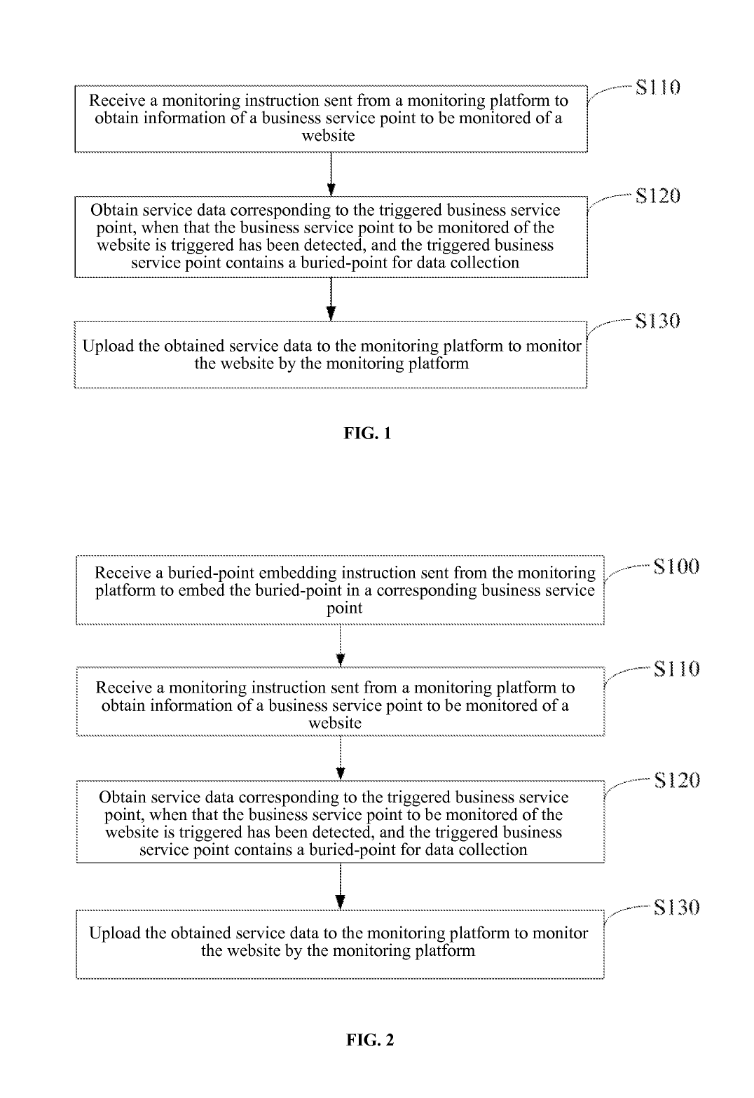

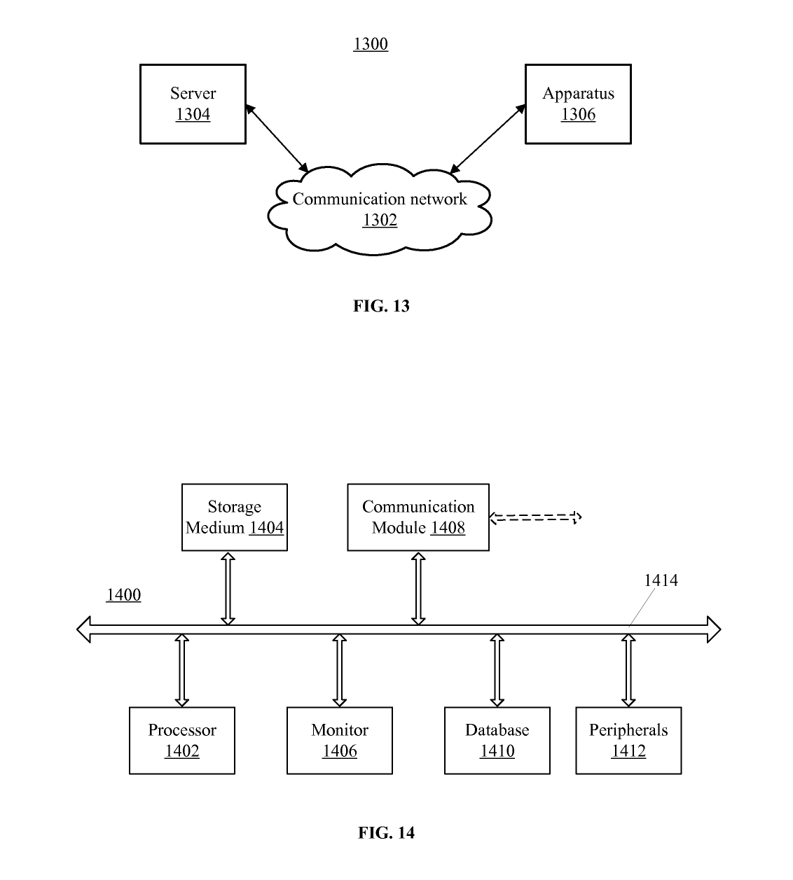

FIGS. 1-12 depict exemplary methods, apparatus, and systems for monitoring a website in accordance with various disclosed embodiments. The exemplary methods, apparatus, and systems can be implemented, for example, in an exemplary environment 1300 as shown in FIG. 13.

As shown in FIG. 13, the environment 1300 can include a server 1304, an apparatus/device 1306, and a communication network 1302. The server 1304 and the apparatus 1306 may be coupled through the communication network 1302 for information exchange, for example, Internet searching, webpage browsing, etc. Although only one apparatus 1306 and one server 1304 are shown in the environment 1300, any number of apparatus 1306 or servers 1304 may be included, and other devices may also be included.

The communication network 1302 may include any appropriate type of communication network for providing network connections to the server 1304 and apparatus 1306 or among multiple servers 1304 or apparatus 1306. For example, the communication network 1302 may include the Internet or other types of computer networks or telecommunication networks, either wired or wireless.

The apparatus 1306 may include any apparatus or device that implemented in the communication network 1302. For example, the apparatus 1306 may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the apparatus 1306 can include a business apparatus, a monitoring platform, and/or any suitable electric device (s).

A server, as used herein, may refer one or more server computers configured to provide certain server functionalities, for example, search engines and database management. A server may also include one or more processors to execute computer programs in parallel.

The server 1304 and the apparatus 1306 may be implemented on any appropriate computing platform. FIG. 14 shows a block diagram of an exemplary computing system 1400 capable of implementing the server 1304 and/or the apparatus 1306. As shown in FIG. 14, the exemplary computer system 1400 may include a processor 1402, a storage medium 1404, a monitor 1406, a communication module 1408, a database 1410, peripherals 1412, and one or more bus 1414 to couple the devices together. Certain devices may be omitted and other devices may be included.

The processor 1402 can include any appropriate processor or processors. Further, the processor 1402 can include multiple cores for multi-thread or parallel processing. The storage medium 1404 may include memory modules, for example, ROM, RAM, and flash memory modules, and mass storages, for example, CD-ROM, U-disk, removable hard disk, etc. The storage medium 1404 may store computer programs for implementing various processes, when executed by the processor 1402.

Further, the peripherals 1412 may include I/O devices, for example, keyboard and mouse, and the communication module 1408 may include network devices for establishing connections through the communication network 1302. The database 1410 may include one or more databases for storing certain data and for performing certain operations on the stored data, for example, webpage browsing, database searching, etc.

In operation, the apparatus 1306 may cause the server 1304 to perform certain actions, for example, an Internet search or other database operations. The server 1304 may be configured to provide structures and functions for such actions and operations. More particularly, the server 1304 may include a data searching system for real-time database searching.

As disclosed, a buried-point can be embedded in a business service point such that, when the business service point is triggered, the buried-point is also triggered to collect service data. As such, according to the collected service data, the monitoring platform can perform the monitoring on the website. There is no need to simulate the user's behavior to monitor the website, while the service data of the business service point truly recorded. These service data can be analyzed and compared. By accumulating the service data, establishing samples, and continuously studying, development trend of the website can be found. Truest reflection of aspects/situations of the business service point of the websites and/or of users using the monitored websites can be provided on the data level. Pre-warnings of unexpected, suddenly-increased, and/or suddenly-decreased service data can be provided to monitor the websites.

FIG. 1 depicts an exemplary method for monitoring a website consistent with various disclosed embodiments. In Step S110, a monitoring instruction sent from a monitoring platform is received to obtain information of the business service point to be monitored.

In an example for electronic commerce (e-commerce), the business service of an e-commerce website includes: merchandise exhibition service, ordering and payment service, merchandise searching service within the website, etc. When a user needs to monitor an operation of a certain business service point, the monitoring instruction containing information corresponding to the business service point can be sent out. As such, when the business apparatus receives the monitoring instruction sent from the monitoring platform, the business apparatus can obtain the information of the business service point to be monitored.

In Step S120, when that the business service point to be monitored of the website is triggered has been detected, and when the triggered business service point contains the buried-point for data collection, service data corresponding to the triggered business service point are obtained.

When a page function (e.g., merchandise browsing) on the webpage is clicked by user, corresponding merchandise exhibition service of the website can be triggered, and the corresponding merchandise information can be obtained and exhibited according to the clicked merchandise item number. When the merchandise cannot be normally browsed due to the abnormal obtaining of merchandise information, the internal program can automatically trigger the exception of the merchandise exhibition service. As such, when it has been detected that the business service of the website is triggered, the business service is responded, and in the meanwhile, it is determined whether the triggered business service includes the buried-point of data collection.

Before implementing Step S110, the buried-point is pre-embedded in the business service point for collecting service data to collect the service data of the business service point. The service data of the business service point can include, e.g., triggered count(s), a current time of the business service point, etc. When the triggered business service includes the buried-point of data collection, the service data corresponding to the triggered business service can be obtained. In various embodiments, the terms “business service” and “business service point” can be used interchangeably.

In Step S130, the obtained service data are uploaded to the monitoring platform.

As disclosed, the buried-point can be embedded in the business service point. When the business service point is triggered, the service data of the business service point can be collected, and reported to the monitoring platform for the monitoring platform to monitor the corresponding website. By embedding the buried-point in the business service point to monitor the website, such method for monitoring a website can be used in a variety of website businesses to obtain real data for finding problems and real data for evaluating business capacity. Efficiency of monitoring the website can be improved.

FIG. 2 depicts another exemplary method for monitoring a website consistent with various disclosed embodiments. Based on the method depicted in FIG. 1, the exemplary method can further include a flexible setting of a buried-point embedded in a business server point.

For example, before the exemplary Step S110 is performed, additional steps can be added. As shown in FIG. 2, in Step S100, a buried-point embedding instruction sent from the monitoring platform is received to embed the buried-point in a corresponding business service point.

For example, by sending the embedding instruction of the buried-point (or the buried-point embedding instruction), the buried-point can be flexibly embedded in the business service point to be monitored. The buried-point can include a counter and a timer. When the business service point is triggered, the counter and timer can be called to record the triggered counts and the current time of the business service point.

In addition, the exemplary step of uploading the obtained service data to the monitoring platform can further include: summarizing the service data corresponding to all of triggered business service points within a pre-set duration, and transmitting the service data to the monitoring platform via a queue (e.g., a data sending queue).

In order to ensure subsequent developments for monitoring the buried-point and to ensure the ability to accept data from the monitoring platform, queue management and asynchronous transmission can be used when uploading data. This can avoid sending a large amount of data to the monitoring platform at a same time. For example, by using the above described time stamp, data aggregation can be performed in a pre-set time, and after aggregating, can be uploaded to the monitoring platform in a queue. In one embodiment, specific coding can be used as follows.

Foreach ($data as $k=>$item){

$key=$item[‘key‘]; // Key requested by the buried-point
$count=$item[‘count‘]; // Value reported by the buried-point
$ip=$item[‘ip‘]; // IP reported by the buried-point
$time=$item[‘time‘]; //Unix timestamp reported by the buried-point
//save to redis
$redis_key=‘r_‘.$key . ‘_‘ .data(‘YmdHi‘,$time); // Use Unix
timestamp to aggregate
data every one minute
$objRedis−>incrby($redis_key,$count);
$objRedis−>expire($redis_key,15*86400);

}

As such, the above-mentioned FUNC is mainly functioned as a data collector, which includes two functional modules: a counter and a timer, for example. When the buried-point code is triggered, FUNC can be called to record one count and a current time. In the meanwhile, the data collector can further record IP information of the business service point for a timely positioning of possible problems of the business service point when monitoring.

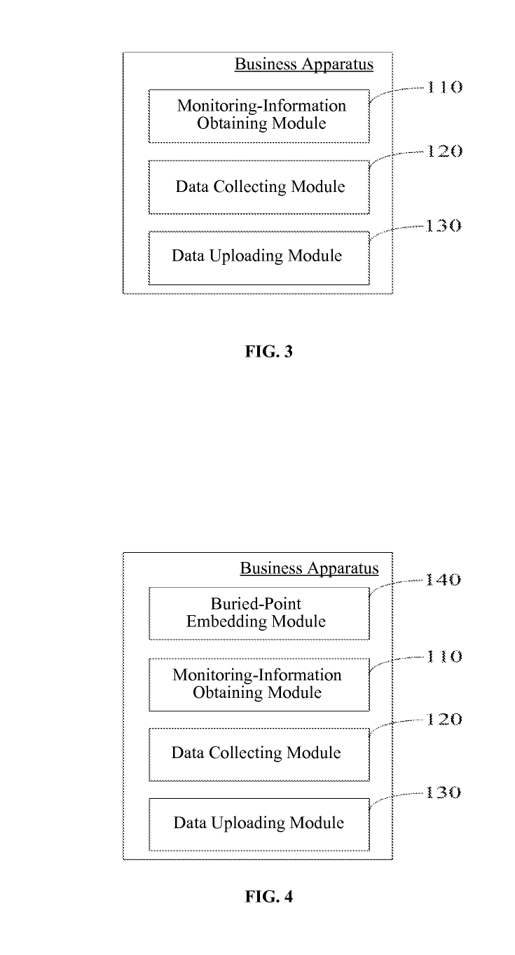

FIG. 3 depicts an exemplary business apparatus having functional modules for monitoring a website consistent with various disclosed embodiments. The exemplary business apparatus includes: a monitoring-information obtaining module 110, a data collecting module 120, and/or a data uploading module 130.

The monitoring-information obtaining module 110 is configured to receive a monitoring instruction sent from a monitoring platform, and obtain information of a business service point to be monitored of a website.

The data collecting module 120 is configured to obtain service data corresponding to the triggered business service point, when it has been detected that the business service point to be monitored of the website is triggered, and when the triggered business service point contains the buried-point for data collection.

The data uploading module 130 is configured to upload the service data to the monitoring platform to monitor the website by the monitoring platform.

The monitoring instruction can contain corresponding information of the business server point. Therefore, when the monitoring-information obtaining module 110 receives the monitoring instruction sent from the monitoring platform, the monitoring information obtaining module 110 can obtain the information of business service point to be monitored.

The data collecting module 120 can detect in real-time whether the business service point to be monitored has been triggered. When the business service point to be monitored is triggered, the data collecting module 120 can determine whether the business service point includes the buried-point for data collection. When the triggered business service includes the buried-point for data collection, the data collecting module 120 can obtain the service data corresponding to the triggered business service. Then the data uploading module 130 can upload the service data to the monitoring platform for the monitoring platform to monitor the website.

As disclosed, the buried-point can be embedded in the business service point. When the business service point is triggered, the service data of the business service point can be collected, and reported to the monitoring platform for the monitoring platform to monitor the corresponding website. By embedding the buried-point in the business service point to monitor the website, such method for monitoring a website can be used in a variety of website businesses to obtain real data for finding problems and real data for evaluating business capacity. Efficiency of monitoring the website can be improved.

FIG. 4 depicts another exemplary business apparatus having functional modules for monitoring a website consistent with various disclosed embodiments. The exemplary business apparatus of FIG. 4 can be based on the apparatus of FIG. 3 and can further include a buried-point embedding module 140.

The buried-point embedding module 140 is configured to receive the buried-point embedding instruction sent from the monitoring platform to embed the buried-point in a corresponding business service point.

For example, by the buried-point embedding instruction, the buried-point can be flexibly embedded in the business service point to be monitored. The buried-point can include a counter and a timer. When the business service point is triggered, the data collecting module 120 can call the counter and timer to record the triggered counts and the current time of the business service point.

The data uploading module 130 is configured, after summarizing the service data corresponding to all of triggered business service points within a pre-set duration, to transmit the service data to the monitoring platform via a queue.

The data uploading module 130 is configured, by using a time stamp, to perform data aggregation in a pre-set time, and after aggregating, to upload to monitoring platform in a queue. As such, before uploading the data, the service data can be firstly aggregated and then uploaded to ensure the subsequent developments for monitoring the buried-point and to ensure the ability to accept data from the monitoring platform.

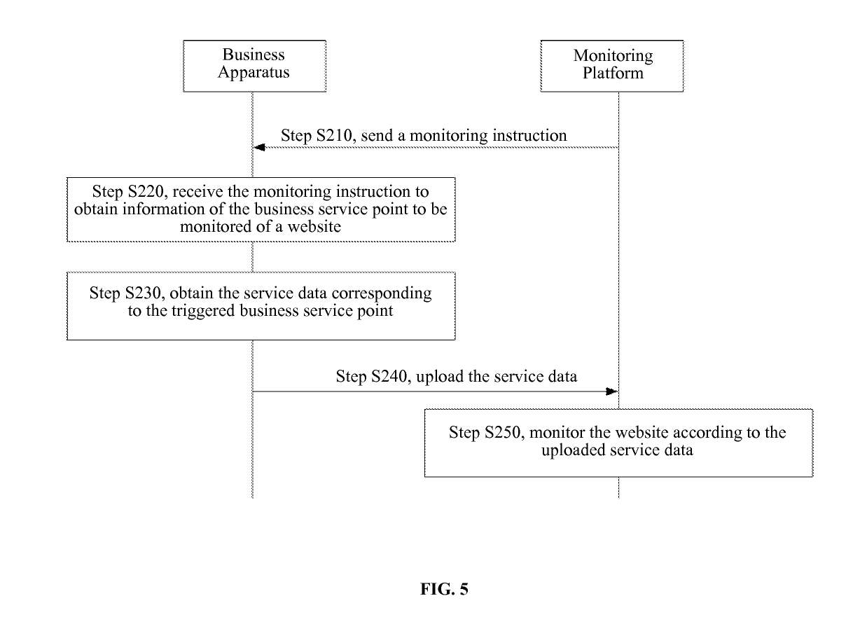

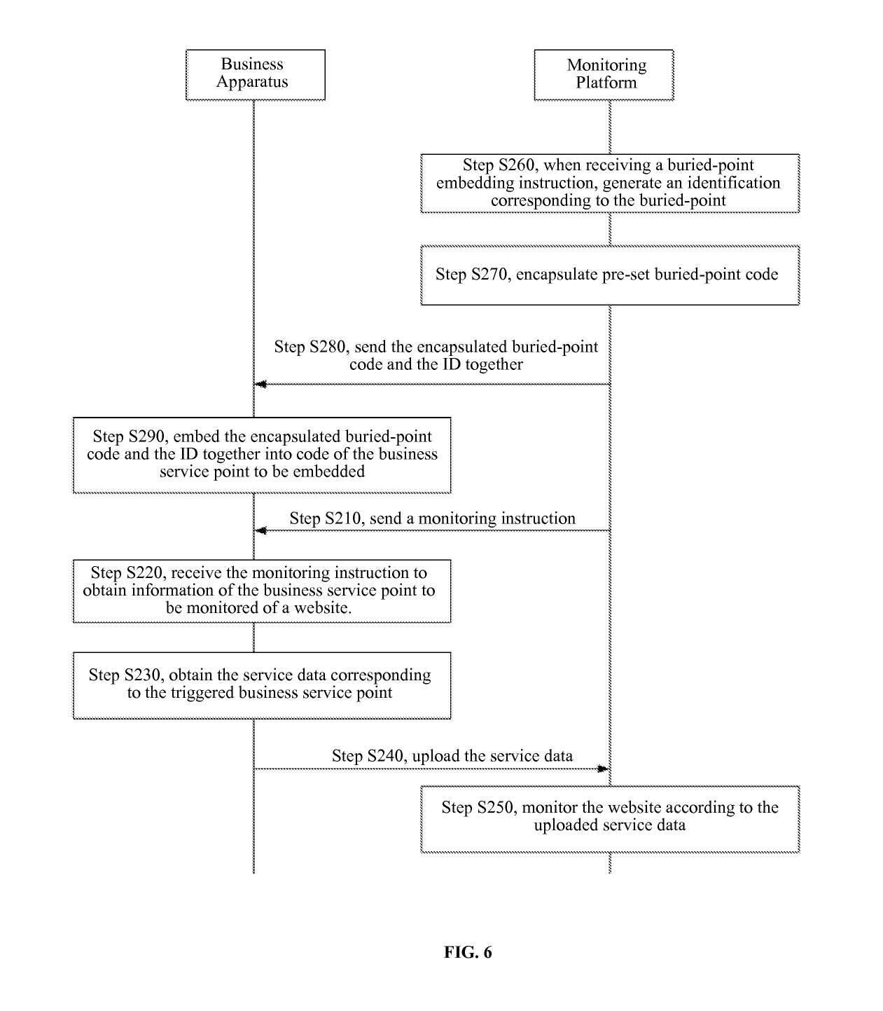

FIG. 5 depicts another exemplary method for monitoring a website consistent with various disclosed embodiments. In Step S210, a monitoring platform sends a monitoring instruction to a business apparatus.

In an example for electronic commerce (e-commerce), the business service of an e-commerce website includes: merchandise exhibition service, ordering and payment service, merchandise searching service within the website, etc. When a user needs to monitor an operation of a certain business service point, the monitoring instruction containing information corresponding to the business service point can be sent out.

In Step S220, the business apparatus receives the monitoring instruction sent from the monitoring platform to obtain information of the business service point to be monitored of a website. For example, when the business apparatus receives the monitoring instruction sent from the monitoring platform, the business apparatus can obtain information of the business service point to be monitored.

In Step S230, the business service obtains the service data corresponding to the triggered business service point, when it has been detected that the business service point to be monitored of the website is triggered, and when the triggered business service point contains the buried-point for data collection.

When a page function (e.g., merchandise browsing) on the webpage is clicked by user, corresponding merchandise exhibition service of the website can be triggered, and the corresponding merchandise information can be obtained and exhibited according to the clicked merchandise item number. When the merchandise cannot be normally browsed due to the abnormal obtaining of merchandise information, the internal program can automatically trigger the exception of the merchandise exhibition service. As such, when it has been detected that the business service of the website is triggered, the business service is responded, and in the meanwhile, it is determined whether the triggered business service includes the buried-point of data collection. When the triggered business service includes the buried-point of data collection, the service data corresponding to the triggered business service can be obtained.

In Step S240, the service data are uploaded to the monitoring platform. Optionally, before uploading the data, the business apparatus performs data aggregation in a pre-set time, and after aggregating, uploads to monitoring platform in a queue. This can ensure the subsequent developments for monitoring the buried-point and ensure the ability to accept data from the monitoring platform.

In Step S250, the monitoring platform monitors the website according to the uploaded service data.

The monitoring platform can analyze the service data according to the uploaded service data. When the service data become abnormal, the monitoring platform provides a warning. Alternatively, each business service point can pre-set counts to be triggered, e.g., to provide business capacity. The business capacity can be dynamically updated by the collected data, and can also be manually updated by business personnel. In one embodiment, the business capacity can use a “day” as a unit. When the triggered counts of the business service point exceeds a pre-set business capacity, warning information can be given to inform the business personnel to re-set the business capacity for the business service point.

As disclosed, the buried-point can be embedded in the business service point. When the business service point is triggered, the service data of the business service point can be collected, and reported to the monitoring platform for the monitoring platform to monitor corresponding website. By embedding the buried-point in the business service point to monitor the website, such method for monitoring a website can be used in a variety of website businesses to obtain real data for finding problems and real data for evaluating business capacity. Efficiency of monitoring the website can be improved.

FIG. 6 depicts another exemplary method for monitoring a website consistent with various disclosed embodiments. For example, the exemplary method of FIG. 6 can be based on the method of FIG. 5 and more steps can be added, e.g., before the Step S210 of FIG. 5.

As shown in FIG. 6, in Step S260, when the monitoring platform receives a buried-point embedding instruction, the monitoring platform generates an identification (ID) corresponding to the buried-point.

The buried-point can be involved in different business types and functions. To distinguish data of buried-points, the monitoring platform can set an identification (e.g., a key) corresponding to each buried-point, and can manage and maintain the identification (ID) of each buried-point. Firstly, a user may request for embedding a buried-point (or have the buried-point accessed) in the monitoring platform, e.g., send out a buried-point embedding instruction. As the business type and function related with the buried-point are different, the functional information of the buried-point needs to be set, when sending out the buried-point embedding instruction. Table 1 lists exemplary functional information of buried-points.

TABLE 1

| | | Buried- | | |
|---|---|---|---|---|
| | | Point | Importance | Business |
| Key of Buried-Point | Function Description | Type | Level | Module |
| ShiftServiceProxy_GetStockBySiteFromCache_Exception | Exception occurs when | De- | OK | CS |
| | obtaining DC and | bugging | | |
| | warehouse information | | | |
| | (info) from the cache | | | |
| ShiftServiceProxy_GetStockBySiteFromCache | Obtain DC and | Business | OK | CS |
| | warehouse info from the | | | |
| | cache | | | |
| SendSMSProxy_SendSMSMessage | Send Yitong network | Business | OK | CS |
| | short message platform | | | |
| SendGisSourceServiceProxy_SendGisSource_Exception | Exception occurs on CS | De- | OK | CS |
| | sending GIS message | bugging | | |
| SendGisSourceServiceProxy_SendGisSource | CS sends GIS message | Business | OK | CS |
| RMAServiceProxy_GetRMAList | Obtain sale information | Business | OK | CS |
| ProductServiceProxy_GetProductV2 | Obtain merchandise | Business | OK | CS |
| | information | | | |
| ProductServiceProxy_GetProductStocksForStockV2 | Obtain merchandise | Business | OK | CS |
| | information | | | |
| ProductServiceProxy_GetProductStocksV2 | Obtain merchandise | Business | OK | CS |
| | information | | | |
| ProductServiceProxy_GetProductStockInfo | Obtain warehouse | Business | OK | CS |
| | number for the | | | |
| | merchandise | | | |

As shown in Table 1, for the first buried-point to be embedded, a business module that the buried-point is embedded therein can be customer system (CS) having a buried-point type of “a debugging type of buried-point” with a function of “exception occurs when obtaining distribution center (DC) and warehouse information from the cache” and an importance level of “ok” (e.g., as a general level or an ordinary level). That is, this buried-point can be embedded in the “CS” business module. When exception occurs as the “CS” business module obtains distribution center (DC) and warehouse information from the cache, the buried-point is triggered, and the abnormal data are collected and then reported. In various embodiments, Table 1 can further include business capacity and/or threshold limitations.

When the monitoring platform receives the buried-point embedding instruction, the monitoring platform can firstly generate a key corresponding to the buried-point embedding instruction as a one-time buried-point ID.

In Step S270, pre-set buried-point code is encapsulated. In Step S280, the encapsulated buried-point code and the ID corresponding to the buried-point together are sent to the business apparatus.

For example, the pre-set buried-point code can be encapsulated, and the encapsulated buried-point code and the Key (or ID) of this buried-point together can be sent to the business apparatus. The buried-point code that is embedded in a corresponding business code in the ‘CS’ business module can be as following.

/// <summary>
/// Report data of monitoring buried-point
/// </summary>
/// <param name = “ monitorkey ” > key value </param> requested
from the monitoring system
Public static void Report(string MonitorKey)
{

Try
{

ECCMonitorClient ist =ECCMonitorClient.GetInstance( );
AsycDelegate myAsycDelegate=new
AsycDelegate(ist.keyCount);
myAsycDelegate.Invoke(MonitorKey);
//return;

}
Catch (Exception e)
{

Console.WriteLine(e.ToString( ));

}

}

In a production environment, in order to be compatible with the business code, the buried-point code must be encapsulated again. Each functional module can then be called. The buried-point code embedded in the business code can include a calling-function report (string monitor Key). When the business service of the business module is triggered, calling function of correspondingly-embedded buried-point can then be triggered. After collecting the data, the collected data/value can be reported.

In Step S290, the business apparatus embeds the encapsulated buried-point code and the identification corresponding to the buried-point together into code of the business service point to be embedded.

For example, after receiving the encapsulated buried-point code and the identification corresponding to the buried-point, the encapsulated buried-point code and the identification corresponding to the buried-point can be embedded in a corresponding business code of the “CS” business module.

In order to ensure subsequent developments for monitoring the buried-point and to ensure the ability to accept data from the monitoring platform, queue management and asynchronous transmission can be used when uploading data. This can avoid sending a large amount of data to the monitoring platform at a same time. For example, by using the above described time stamp, data aggregation can be performed in a pre-set time, and after aggregating, can be uploaded to the monitoring platform in a queue.

FIG. 7 depicts an exemplary method for monitoring uploaded service data when monitoring a website consistent with various disclosed embodiments.

In Step S251, the monitoring platform receives the uploaded service data to store in a corresponding database listing. In Step S252, the stored service data can be drawn into a graph and then displayed.

After receiving the uploaded service data, the monitoring platform can store the service data in the corresponding database listing according to the ID of the service data, then using a graph conversion function of the monitoring platform to draw the graph from the stored service data and then to display the graph.

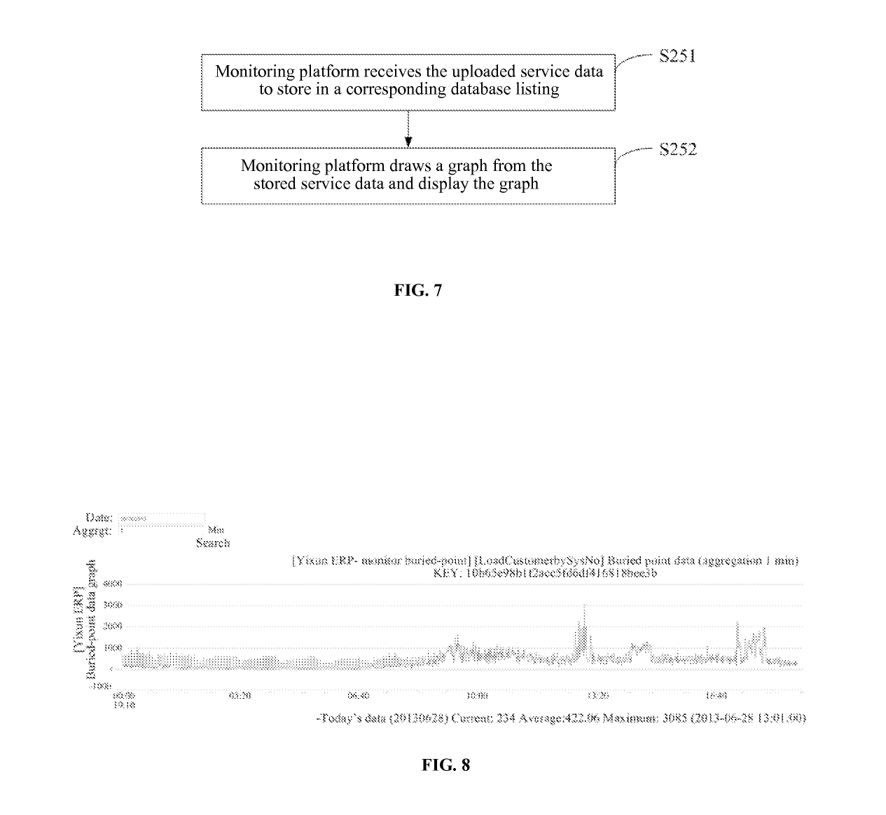

As shown in FIG. 8, actual usage situation of a certain function point in current business can be displayed. As such, by displaying the graph of the business, the monitoring platform can clearly know about the usage situation of each function point of the business, and can also timely know about: which function point is long-welcomed and used by users, and/or which function or business is often neglected or barely known by users. This can provide clear and effective data basis for a development direction of the merchandises.

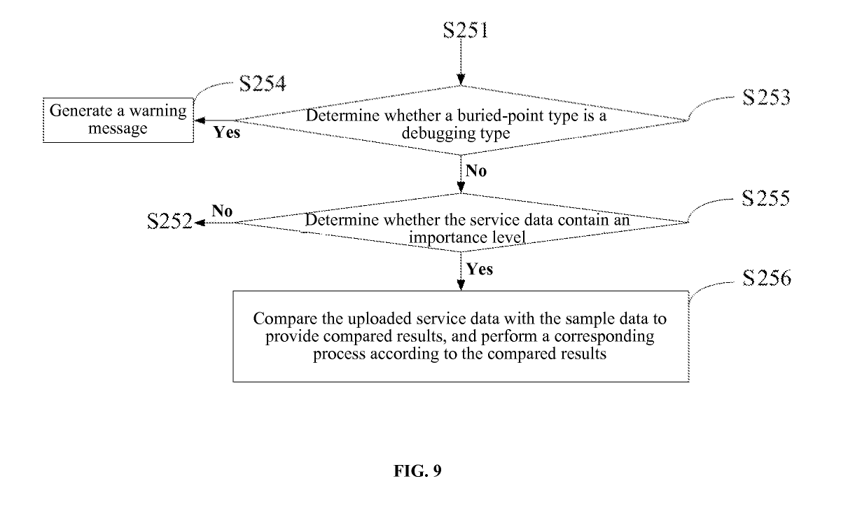

FIG. 9 depicts another exemplary method for monitoring uploaded service data when monitoring a website consistent with various disclosed embodiments. The exemplary method of FIG. 9 can be based on the method of FIG. 7 with additional exemplary steps.

For example, after Step 251 of FIG. 7, in Step S253 of FIG. 9, the monitoring platform receives the uploaded service data, and determines whether a buried-point type corresponding to the service data is a debugging type of buried-point or a business type of buried-point.

In Step S254, a warning message is generated. In Step S255, whether the service data contain an importance level is determined. When the service data contain the importance level, the method proceeds to implement Step S246. Otherwise, when the service data does not contain any importance level, the method proceeds to implement Step S252.

In Step S256, when the service data contain the importance level, the monitoring platform obtains sample data corresponding to the importance level of the service data, compares the uploaded service data with the sample data to provide compared results, and performs a corresponding process according to the compared results.

In one embodiment, a sample zone (e.g., including a sample pool) of a set of standard data can be originally (or otherwise previously) configured. The sample zone can be configured as following formulas.

Sample collecting value=(current data+previous data)/2 (I)

Upper limit value of the sample zone=Sample collecting value*(1+sample change rate %) (II)

Lower limit value of the sample zone=Sample collecting value*(1−sample change rate %) (III)

The sample collecting value can be stored in a sample library. While the sample change rate can be strategically, manually adjusted according to different businesses. The sample library can include, e.g., three types of samples, such as contemporaneous samples, recent samples, and/or special samples.

The contemporaneous samples can include sample data compared with contemporaneous standard data when the business is occurring at a same period of time. For example, sample data occurred at 10:00 am on a Monday can be compared with sample data occurred at 10:00 am on a previous Monday (e.g., which can be used as standard data). The recent samples can include sample data compared with sample data generated at the same time of a previous day (e.g., “yesterday”). The special sample can include sample data of samples having special requirements with respect to weekends, holidays, and/or e-sales. In other words, the special samples can include standard business volume data generated not for usual days, which are not comparable with general business data.

In an exemplary service of uploading information of a user under a “CS” business module based on the user SysNo, the monitoring platform may distribute an ID 10b65e98b1f2acc5fd6df416818bee3b for the buried-point. In this example, a current sample is sampled on Friday, Jun. 28, 2013. A collecting process of this buried-point can be started at a same and fixed time every day (e.g., around 1 o'clock in the morning every day) to capture contemporaneous samples collected on a previous Friday for ID 10b65e98b1f2acc5fd6df416818bee3b and to capture the previous day's samples (e.g., on Friday, Jun. 27, 2013). According to formula (I), calculations can be made to obtain the contemporaneous sample(s) and recent sample(s) of Friday. The contemporaneous sample(s) can be used for comparison with samples collected on a following Friday (e.g., Jul. 5, 2013), while the recent sample(s) can be used for comparison with samples collected on a following day.

For example, a data group may include data on Jun. 28, 2013 collected between 12:30 and 13:00 for about half an hour (e.g., each datum is collected every 5 minutes) to include data of [1787, 1160, 2138, 5037, 1665, and 5675]. The contemporaneous samples collected on the previous Friday between 12:30 and 13:00 can include data of [4131, 2474, 2017, 810, 2331, and 2027]. Sample data for the following Friday on Jun. 28, 2013 may be calculated to include data of: [2959, 1817, 2077, 2923, 1998, 3851]. Recent samples on Jun. 27, 2013 collected between 12:30 and 13:00 can include data of: [923, 3083, 309, 818, 712, and 1556]. Following (or a new) recent samples on Jun. 28, 2013 can be calculated to include data of: [1355, 2121, 1223, 2927, 1188, and 3615]. When compared with a sample zone, e.g., the sample zone on Jun. 29, 2013, the compared recent samples can have upper amplitude of about 100% and lower amplitude of about 100%. After calculation, the recent samples can be in intervals of [[0-2710], [0-4242], [0-2446], [0-5854], [0-2376], and [0-7230]].

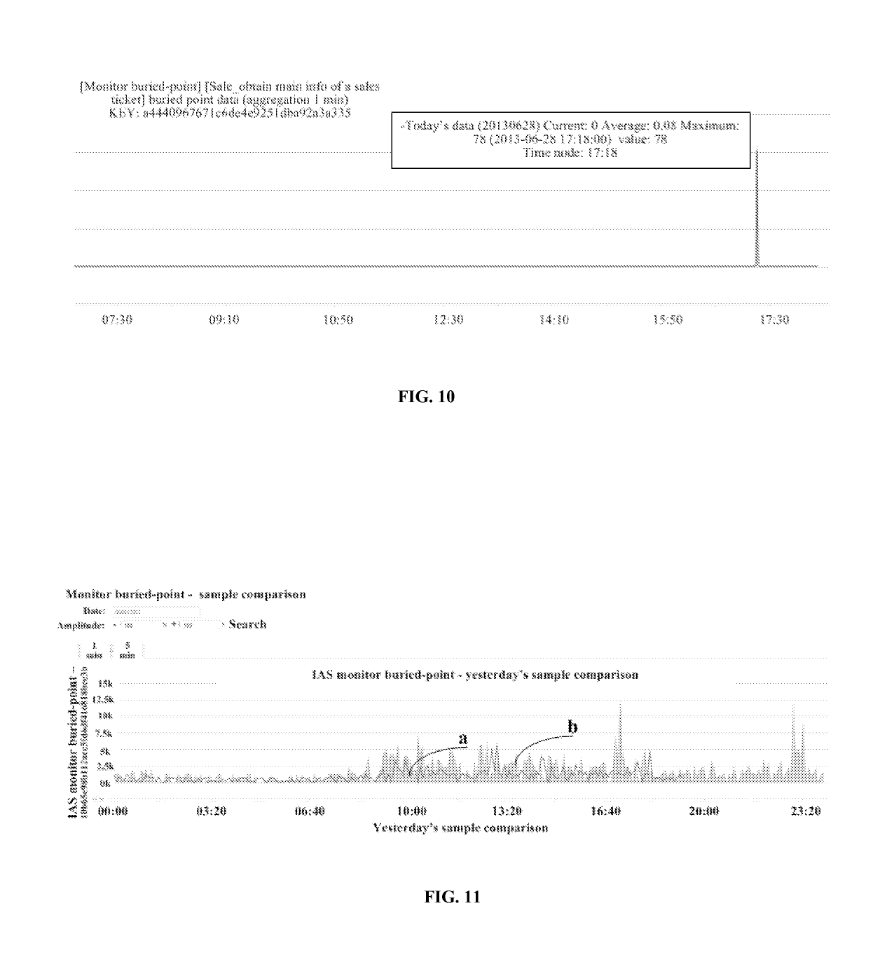

Because the debugging buried-point (or the debugging type of buried-point) is triggered when the data is reported to be abnormal (or an exception), warning message can be generated without comparing sample data. FIG. 10 depicts an exemplary monitoring graph displayed when monitoring a website as shown in FIG. 7 having a monitored buried-point of a debugging buried-point consistent with various disclosed embodiments. As shown in FIG. 10, the buried-point is a debugging buried-point denoting a service of “obtaining main information of a sales ticket” in a storage and delivery system. As shown, data reported on a time of 17:18 is about 78. That is, main information of sales tickets of 78 ordering forms cannot be obtained. As such, when the abnormal data in this debugging buried-point have been detected, a warning is triggered.

On the other hand, for a business buried-point, warning messages can be generated according to compared results after processing the sample data comparison. For example, corresponding processes can be performed according to an importance level of the business buried-point. When the importance level of the business buried-point indicates an unimportant business, there is no need to process the sample comparison, a graph of service data can be directly displayed. When the importance level the business buried-point indicates an OK level, the uploaded service data can be compared with the contemporaneous samples. When the uploaded service data fall outside of the scope of the contemporaneous samples, a warning message can be generated. When the importance level of the business buried-point indicates an importance level, the uploaded service data can be compared with all of the above-mentioned sample data (e.g., contemporaneous samples, recent samples, and/or special samples). When the uploaded service data fall outside of the scope of any of above-mentioned sample data, a warning message can be generated.

As shown in FIG. 11, curve a can indicate currently-collected service data, and gray area b indicates sample zone for comparing with the service data. As illustrated, when the service data fall outside of the scope of the sample zone, a warning message can be generated.

The warning message can timely inform corresponding business personnel, e.g., by SMS, E-mails, and any suitable methods, such that corresponding business personnel can timely process. Table 2 illustrates a warning message generated by the monitoring platform in an exemplary method for monitoring a website consistent with various disclosed embodiments.

TABLE 2
Pre-warning for monitor buried-point exception data

Service: RMA−>Sale_GetSOMasterInfo (Sale_obtain main info of a
sales ticket)
App_Key: a4440967671c6de4e9251dba92a3a335
pre-warning cause: service received exception data report at 17:18:01
on June 28, 2013. Data: 78, please pay attention
Note:
this mail is automatically sent by ** platform from: ***, ****

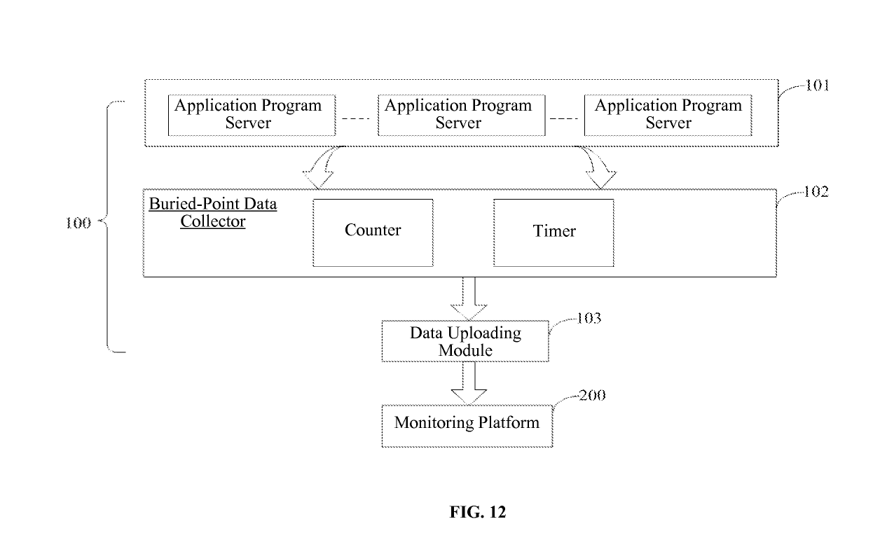

Corresponding to methods disclosed herein, an exemplary system for monitoring a website can be provided. As shown in FIG. 12, an exemplary system for monitoring a website includes: a business apparatus 100, and/or a monitoring platform 200.

The business apparatus 100 is configured, when it has been detected that a business service of a website is triggered, to determine whether the triggered business service includes the buried-point of data collection. When the triggered business service includes the buried-point of data collection, the business apparatus 100 is configured to obtain the service data corresponding to the triggered business service, and upload to the monitoring platform 200.

The monitoring platform 200 is configured to monitor the website according to the uploaded service data. The business apparatus 100 includes an application program server cluster 101 and a buried-point data collector 102 for undertaking the business.

The application program server cluster 101 can be embedded within the buried-point for data collection. Once one server is triggered, this one server can collect corresponding service data, and send the service data to the buried-point data collector 102. The buried-point data collector 102 can include at least two function modules: a counter and a timer. Whenever the buried-point code in the server is triggered, the buried-point data collector 102 can record one count and a current time, and use a data uploading module 130 to upload the collected data to the monitoring platform 200.

In order to ensure subsequent developments for monitoring the buried-point and to ensure the ability to accept data from the monitoring platform 200, data transmission between the business apparatus 100 and the monitoring platform 200 can be performed by data queue management, e.g., in a communication network as shown in FIG. 13. In the meanwhile, after the business apparatus 100 uses the data uploading module 130 to summarize the collected data within a pre-set time, the collected data can be upload to the monitoring platform 200 in a queue.

The monitoring platform 200 can provide a flexible setting for embedding the buried-point. For example, the monitoring platform 200 is configured, when receiving the buried-point embedding instruction, to generate an ID corresponding to the buried-point; to encapsulate buried-point code that is pre-set, and to embed the encapsulated buried-point code and the ID corresponding to the buried-point together into code of the business service point to be embedded.

The monitoring platform 200 can perform a displaying function of the service data. For example, the monitoring platform 200 is further configured to receive the uploaded service data to store in a corresponding database listing, and to draw a graph from the stored service data and to display the graph.

The monitoring platform 200 can perform a warning function of the service data. For example, the monitoring platform 200 is further configured to receive the uploaded service data, and to determine whether the buried-point type corresponding to the service data is a debugging buried-point or a business buried-point.

The monitoring platform 200 is further configured to generate a warning message, when the buried-point type corresponding to the service data is the debugging buried-point, and to determine whether the service data contain the importance level, when the buried-point type corresponding to the service data is the business buried-point.

When the service data contain the importance level, the monitoring platform 200 is further configured to obtain sample data corresponding to the importance level of the service data, to compare the uploaded service data with the sample data to provide compared results, and to perform the corresponding process according to the compared results. When the service data do not contain the importance level, the monitoring platform 200 is further configured to draw the graph from the uploaded service data and displaying the graph.

In various embodiments, the monitoring platform includes a buried-point-identification generating module and a buried-point-code encapsulating module. The buried-point-identification generating module is configured to generate an identification corresponding to the buried-point, when the monitoring platform receives the buried-point embedding instruction. The buried-point-code encapsulating module is configured to encapsulate buried-point code that is pre-set, and to send the encapsulated buried-point code and the identification corresponding to the buried-point together to the business apparatus. The business apparatus is further configured to embed the encapsulated buried-point code and the identification corresponding to the buried-point together into code of the business service point to be embedded.

The data uploading module is further configured, after summarizing the service data corresponding to all of triggered business service points within a pre-set duration, to transmit the service data to the monitoring platform via a queue. The monitoring platform further includes a storing module and a buried-point-data processing module. The storing module is configured to receive the uploaded service data to store in a corresponding database listing. The buried-point-data processing module is configured to draw a graph from the stored data and display the graph.

The monitoring platform further includes a buried-point-type determining module, a debugging-buried-point processing module, and a business-buried-point processing module. The buried-point-type determining module is configured to receive the uploaded service data, and determine whether a buried-point type corresponding to the service data is a debugging buried-point or a business buried-point. The debugging-buried-point processing module is configured to generate a warning message when the buried-point type corresponding to the service data is the debugging buried-point.

The business-buried-point processing module is configured to determine whether the service data contain an importance level, when the buried-point type corresponding to the service data is the business buried-point. When the service data contain the importance level to obtain sample data corresponding to the importance level of the service data, the business-buried-point processing module is configured to compare the uploaded service data with the sample data to provide compared results, and to perform a corresponding process according to the compared results. When the service data do not contain the importance level, the business-buried-point processing module is configured to draw a graph from the uploaded service data and to display the graph.

It should be noted that, in the present disclosure each embodiment is progressively described, i.e., each embodiment is described and focused on difference between embodiments. Similar and/or the same portions between various embodiments can be referred to with each other. In addition, exemplary apparatus and systems are described with respect to corresponding methods.

The disclosed methods, apparatus, and/or systems can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The methods, apparatus, and systems can be implemented in a software manner. Of course, the methods, apparatus, and systems can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods, apparatus, and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods, apparatus, and systems for monitoring a website are provided. A monitoring instruction sent from a monitoring platform is received to obtain information of a business service point to be monitored of the website. Service data corresponding to the triggered business service point are obtained, when that the business service point to be monitored of the website is triggered has been detected, and when the triggered business service point contains a buried-point for data collection. The obtained service data are then updated to the monitoring platform for the monitoring platform to monitor the website. A system includes a business apparatus and a monitoring platform. A business apparatus includes a monitoring-information obtaining module, a data collecting module, and a data uploading module.

As disclosed, the buried-point can be embedded in the business service point. When the business service point is triggered, the service data of the business service point can be collected, and reported to the monitoring platform for the monitoring platform to monitor the corresponding website. By embedding the buried-point in the business service point to monitor the website, such method for monitoring a website can be used in a variety of website businesses to obtain real data for finding problems and real data for evaluating business capacity. Efficiency of monitoring the website can be improved.

In order to ensure subsequent developments for monitoring the buried-point and to ensure the ability to accept data from the monitoring platform, queue management and asynchronous transmission can be used when uploading data. This can avoid sending a large amount of data to the monitoring platform at a same time. For example, by using the above described time stamp, data aggregation can be performed in a pre-set time, and after aggregating, can be uploaded to the monitoring platform in a queue.

What is claimed is:

1. A method of monitoring a website, comprising:
receiving a monitoring instruction sent from a monitoring platform to obtain information of a business service point to be monitored of the website;
obtaining service data corresponding to the triggered business service point, when that the business service point to be monitored of the website is triggered has been detected, and when the triggered business service point contains a buried-point for data collection; and
uploading the obtained service data to the monitoring platform for the monitoring platform to monitor the website.

2. The method according to claim 1, wherein before receiving the monitoring instruction sent from the monitoring platform to obtain the information of the business service point to be monitored, the method further includes:
receiving a buried-point embedding instruction sent from the monitoring platform to embed the buried-point in a corresponding business service point.

3. The method according to claim 2, wherein obtaining the service data corresponding to the triggered business service point includes:
recording a triggered count and a current time of the business service point, when the business service point is being triggered.

4. The method according to claim 3, wherein uploading the obtained service data to the monitoring platform includes:
summarizing the service data corresponding to all of triggered business service points within a pre-set duration, and
transmitting the service data to the monitoring platform via a queue.

5. A business apparatus, comprising:
a monitoring-information obtaining module, configured to receive a monitoring instruction sent from a monitoring platform, and obtain information of a business service point to be monitored of the website;
a data collecting module, configured to obtain service data corresponding to the triggered business service point, when that the business service point to be monitored of the website is triggered has been detected, and when the triggered business service point contains a buried-point for data collection; and
a data uploading module, configured to upload the service data to the monitoring platform to monitor the website by the monitoring platform.

6. The apparatus according to claim 5, further including:
a buried-point embedding module, configured to receive a buried-point embedding instruction sent from the monitoring platform to embed the buried-point in a corresponding business service point.

7. The apparatus according to claim 6, wherein the data collecting module contains a counter and a timer, wherein the counter is configured to record a triggered count of the business service point and the timer is configured to record a current time of the business service point, when the business service point is being triggered.

8. The apparatus according to claim 7, wherein the data uploading module is configured, after summarizing the service data corresponding to all of triggered business service points within a pre-set duration, to transmit the service data to the monitoring platform via a queue.

9. A method of monitoring a website, comprising:
receiving, by a business apparatus, a monitoring instruction sent from a monitoring platform to obtain information of a business service point to be monitored;
obtaining, by the business apparatus, service data corresponding to the triggered business service point, when that the business service point to be monitored of the website is triggered has been detected, and when the triggered business service point contains a buried-point for data collection; and
uploading, by the business apparatus, the obtained service data to the monitoring platform to monitor the website by the monitoring platform,
wherein the monitoring platform monitors the website according to the uploaded service data.

10. The method according to claim 9, wherein before the business apparatus receiving the monitoring instruction sent from the monitoring platform to obtain the information of the business service point to be monitored, the method further includes:
generating an identification corresponding to the buried-point, when the monitoring platform receives the buried-point embedding instruction;
encapsulating buried-point code that is pre-set, and sending the encapsulated buried-point code and the identification corresponding to the buried-point together to the business apparatus; and
embedding, by the business apparatus, the encapsulated buried-point code and the identification corresponding to the buried-point together into code of the business service point to be embedded.

11. The method according to claim 9, wherein uploading, by the business apparatus, the obtained service data to the monitoring platform to monitor the website by the monitoring platform includes:
after summarizing the service data corresponding to all of triggered business service points within a pre-set duration, transmitting the service data to the monitoring platform via a queue.

12. The method according to claim 11, wherein the monitoring platform monitoring the website according to the uploaded service data includes:
receiving, by the monitoring platform, the uploaded service data to store in a corresponding database listing; and
drawing a graph from the stored service data and displaying the graph.

13. The method according to claim 9, wherein the monitoring platform monitoring the website according to the uploaded service data includes:
receiving, by the monitoring platform, the uploaded service data, and determining whether a buried-point type corresponding to the service data is a debugging buried-point or a business buried-point; and
generating a warning message, when the buried-point type corresponding to the service data is the debugging buried-point; or
determining whether the service data contain an importance level, when the buried-point type corresponding to the service data is the business buried-point;
when the service data contain the importance level, obtaining sample data corresponding to the importance level of the service data, comparing the uploaded service data with the sample data to provide compared results, and performing a corresponding process according to the compared results;
when the service data do not contain the importance level, drawing a graph from the uploaded service data and displaying the graph.

14. A system of monitoring a website, comprising:
a business apparatus and a monitoring platform, wherein the business apparatus includes:
a monitoring-information obtaining module, configured to receive a monitoring instruction sent from a monitoring platform, and obtain information of a business service point to be monitored of the website;
a data collecting module, configured to obtain service data corresponding to the triggered business service point, when that the business service point to be monitored of the website is triggered has been detected, and when the triggered business service point contains a buried-point for data collection; and
a data uploading module, configured to upload the service data to the monitoring platform to monitor the website by the monitoring platform,
wherein the monitoring platform is configured to monitor the website according to the uploaded service data.

15. The system according to claim 14, wherein the monitoring platform includes:
a buried-point-identification generating module, configured to generate an identification corresponding to the buried-point, when the monitoring platform receives the buried-point embedding instruction;
a buried-point-code encapsulating module, configured to encapsulate buried-point code that is pre-set, and to send the encapsulated buried-point code and the identification corresponding to the buried-point together to the business apparatus; and
wherein the business apparatus is further configured to embed the encapsulated buried-point code and the identification corresponding to the buried-point together into code of the business service point to be embedded.

16. The system according to claim 14, wherein the data uploading module is further configured, after summarizing the service data corresponding to all of triggered business service points within a pre-set duration, to transmit the service data to the monitoring platform via a queue.

17. The system according to claim 16, wherein the monitoring platform further includes:
a storing module, configured to receive the uploaded service data to store in a corresponding database listing; and
a buried-point-data processing module, configured to draw a graph from the stored data and display the graph.

18. The system according to claim 14, wherein the monitoring platform further includes:
a buried-point-type determining module, configured to receive the uploaded service data, and determine whether a buried-point type corresponding to the service data is a debugging buried-point or a business buried-point;
a debugging-buried-point processing module, configured to generate a warning message when the buried-point type corresponding to the service data is the debugging buried-point; and
a business-buried-point processing module, configured to determine whether the service data contain an importance level, when the buried-point type corresponding to the service data is the business buried-point; when the service data contain the importance level to obtain sample data corresponding to the importance level of the service data, to compare the uploaded service data with the sample data to provide compared results, and to perform a corresponding process according to the compared results; and when the service data do not contain the importance level, to draw a graph from the uploaded service data and to display the graph.
